(19) United States
(12) Patent Application Publication
(10) Pub. No.: US 2025/0275640 A1
(43) Pub. Date: Sep. 4, 2025

(54) WINE GLASS

(71) Applicant: LEROY RICHARDSON, Aiken, SC (US)

(72) Inventor: LEROY RICHARDSON, Aiken, SC (US)

(21) Appl. No.: 18/796,268

(22) Filed: Aug. 6, 2024

Related U.S. Application Data
(60) Provisional application No. 63/561,021, filed on Mar. 4, 2024.

(51) Int. Cl. A47G 19/22; B01F 35/53; B01F 101/17

(52) U.S. Cl. CPC A47G 19/2205; B01F 35/531; B01F 2101/17

(57) ABSTRACT

A wine glass including a bowl, a stem, and a base. The wine glass further includes an agitator integral in the center of the bowl for imparting a swirling motion to the wine poured into the bowl.

### CROSS-REFERENCE TO RELATED APPLICATIONS

This application claims priority from a U.S. Provisional Patent Appl. No. 63/561,021, filed on Mar. 4, 2024, which is incorporated herein by reference in its entirety.

### FIELD OF INVENTION

The present invention relates to a wine glass, and more particularly, the present invention relates to a wine glass with an integral agitator for swirling the wine.

BACKGROUND

Usually, food and drinks are enjoyed slowly to appreciate all the flavors, but savoring a glass of wine is unique. Savoring wine isn't just about the taste, it is a sensory experience enhanced by the aromas and subtleties. Wine lovers don't just drink wine; they take in the sight, aromas, taste, and texture. Experienced wine enthusiasts often swirl the wine in the glass to release the aromas. However, both novice and experienced wine lovers can struggle with swirling the wine without spilling it. This can make it difficult to fully enjoy the experience of savoring wine.

Therefore, a wine glass that allows proper swirling of the wine in the glass to release the aromas for a full sensory wine-savoring experience is appreciated.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a wine glass for enhancing the swirling of the wine.

Another object of the present invention is that the wine glass has a shape and size like a standard wine glass.

Still, another object of the present invention is that the wine glass is economical to manufacture.

Yet another object of the present invention is that the wine glass can be washed like a normal glass.

In one aspect, disclosed is a wine glass comprising a bowl configured to contain wine; and an agitator integral in a center of the bowl and configured for imparting swirl motion to the wine poured into the wine glass. The agitator is of a shape resembling a frustum cone with curved edges. The wine glass further comprises a stem extending from a bottom of the bowl; and a base supporting the stem.

### BRIEF DESCRIPTION OF DRAWINGS

The accompanying figures incorporated herein form part of the specification and illustrate embodiments of the present invention. Together with the description, the figures further explain the principles of the present invention and enable a person skilled in the relevant arts to make and use the invention.

FIG. 1 is a front view of a wine glass, according to an exemplary embodiment of the present invention.

FIG. 2 is a sectional view of the wine glass showing an agitator, according to an exemplary embodiment of the present invention.

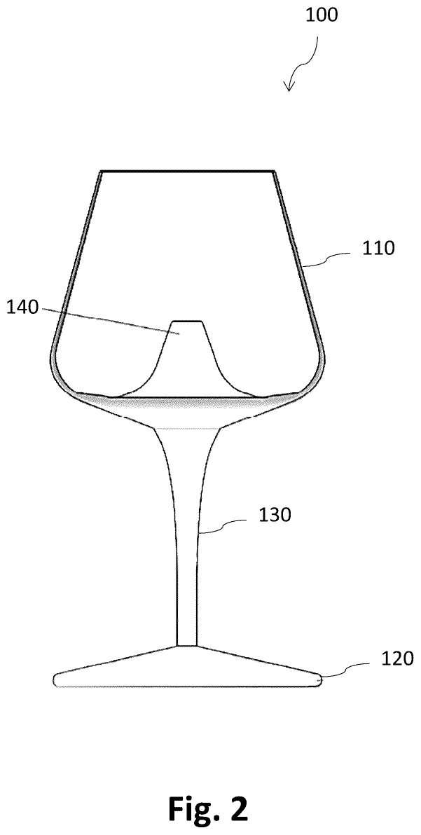

FIG. 3 is a top view of the wine glass, according to an exemplary embodiment of the present invention.

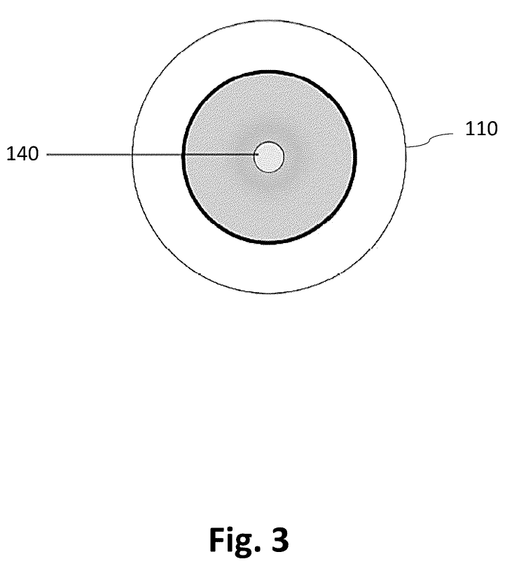

FIG. 4 is a bottom view of the wine glass, according to an exemplary embodiment of the present invention.

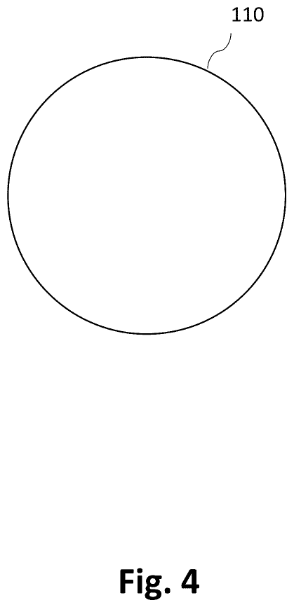

FIG. 5 shows a sectional view of a bowl without a stem, according to an exemplary embodiment of the present invention.

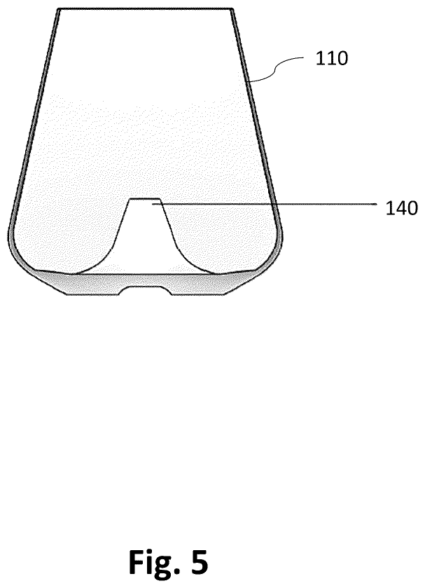

FIG. 6 shows the base of the wine glass, according to an exemplary embodiment of the present invention.

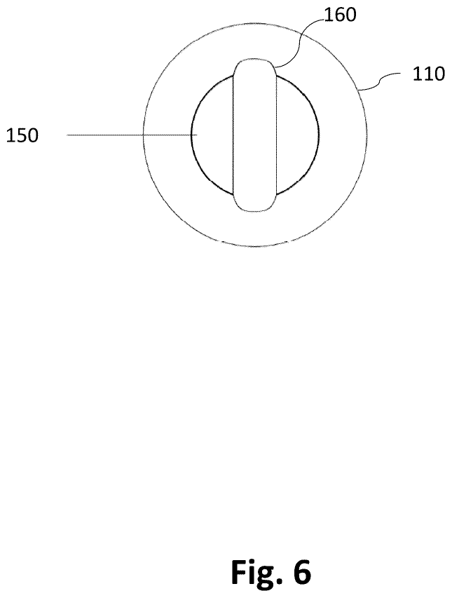

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting of embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The described invention pertains to a wine glass designed to enhance the enjoyment of wine. The bowl of the disclosed wine glass can be similar a standard wine glass. The disclosed wine glass may include an agitator that can be integral in the center of the bowl for imparting swirl motion to the wine contained in the bowl. The swirling of the wine in the bowl by the agitator can be efficient with more vibrations, which allows the aromas from the wine to be released providing a full sensory experience of savoring the glass of wine.

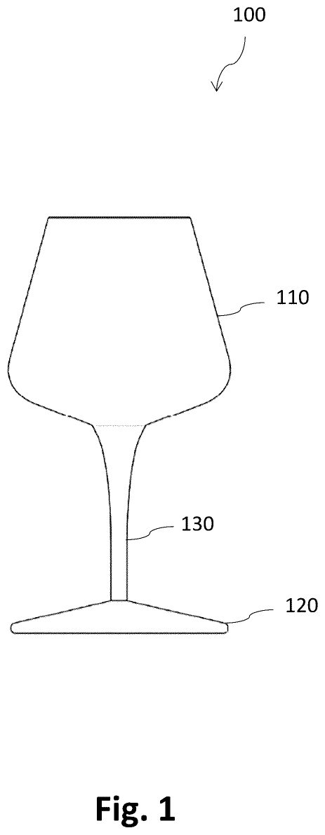

Referring to FIG. 1 which is a front view of the wine glass 100 that includes a bowl 110, a base 120, and a stem 130, wherein the stem extends between the bowl and the base. The shape and size of the wine glass correspond to a standard wine glass; however, the shape and size can be varied without departing from the scope of the present invention. For example, the stem and the base can be optional. Wine glass can be made from any suitable material, such as glass. Moreover, the bowl, the stem, and the base can be made from the same material or different suitable materials. Also, the bowl, the stem, and the base can be manufactured as an integral unit or can be manufactured separately which can be assembled later.

The wine glass described here contains an agitator 140 positioned at the bottom of the bowl, preferably at the center. It's important to note that the location of the agitator within the bowl can be changed without going beyond the scope of the current invention. The agitator may be an integral part of the bowl, meaning it can be manufactured together with the bowl. Alternatively, the agitator may be manufactured separately and then attached to the center of the bowl.

The agitator can be designed to impart a slow swirl motion that slowly releases aroma from the wine, appears pleasant and exciting, and does not affect sipping from the wine glass.

When wine is poured into the glass, it creates turbulence as it interacts with the agitator. The user can enhance this turbulence by gently swirling the glass. The agitator, as depicted in the illustration, resembles a volcano-shaped protrusion. Also, it can be said that the agitator is shaped like a frustum cone with a curved wall.

In certain implementations, the surface of the agitator can be configured to have ridges, grooves, and the like that can enhance the turbulence in the wine under motion.

The disclosed apparatus, by promoting a more efficient swirl, allows more air into the wine, releasing its full bouquet of aromas that rest in the glass. For those unfamiliar with the benefits of swirling, the agitator acts as a guide, sparking interest and encouraging a new dimension to the enjoyment of wine. The innovatively crafted wine glass amplifies the pleasure of sipping by highlighting the aromatic symphony within each pour. The agitator is designed to promote a more efficient swirl, ensuring better aeration of the wine, and thereby intensifying its aromatic profile. The disclosed apparatus can also be used by those wanting to learn or teach about the significance of swirling in wine appreciation. The disclosed apparatus may be suitable for a variety of wines, from reds to whites, allowing users to optimize their experience with different varieties. The swirling action by the disclosed device can be better than manual swirling by wine enthusiasts allowing them to appreciate more fully the complexities of wine and seek to enhance their tasting experience. The disclosed apparatus can come in handy for novice wine drinkers presenting a new world of wine for them. The disclosed apparatus can provide an easily accessible way to explore and enjoy the nuances of different varietals.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A wine glass comprising:
a bowl configured to contain wine; and
an agitator integral in a center of the bowl and configured for imparting swirl motion to the wine poured into the wine glass.

2. The wine glass according to claim 1, wherein the agitator is of a shape resembling a frustum cone with curved edges.

3. The wine glass of claim 1, wherein the wine glass further comprises:
a stem extending from a bottom of the bowl; and
a base supporting the stem.
